(19) United States
(12) Patent Application Publication
(10) Pub. No.: US 2011/0035481 A1
(43) Pub. Date: Feb. 10, 2011

(54) System and Method for Navigating and Accessing Resources on Private and/or Public Networks

(75) Inventors: Barjinderpal S. Gill, Los Gatos, CA (US); Paramjit S. Gill, Ottawa (CA); Chung Ming Tam, Ottawa (CA); Stefan Van Kessel, Ottawa (CA)

Correspondence Address: MBM Intellectual Property Law LLP, 270 ALBERT STREET, 14TH FLOOR, OTTAWA, ON, K1P 5G8, CA

(73) Assignee: TOPEER CORPORATION, Ottawa, ON (CA)

(21) Appl. No.: 12/866,420

(22) PCT Filed: Feb. 12, 2009
(86) PCT No.: PCT/CA09/00152

§ 371 Date: Oct. 27, 2010

(30) Foreign Application Priority Data
Feb. 12, 2008 (CA) 2620939

(51) Int. Cl. G06F 15/173

(52) U.S. Cl. 709/223

(57) ABSTRACT

The application discloses a system and method for navigating and accessing resources on private and public networks. The system allows users of a private network to register labels associated with network resources of any associated private or public network, on a database stored on one or more servers. The database allows for searching of network resources based on labels, thus allowing users to navigate resources not only on their private network, but on associated private or public networks.

### FIELD OF THE INVENTION

The present invention pertains to the creation of a system and method to facilitate discovery of resources within a private network, between a plurality of private networks or between private and public networks.

### BACKGROUND OF THE INVENTION

Navigating and accessing network resources is a common but difficult problem in computer science. In small private networks, directory services are used by a central network administrator to organize and manage the devices connected to the network. Users on such private networks can then locate and access the devices using the directory service (Sheresh and Sheresh, 2001). In large public networks such as the Internet, the Domain Name System (DNS) represents a type of directory service that allows users to identify computing devices connected to the Internet. For a DNS system, the Internet Corporation for Assigned Names and Numbers (ICANN), represents the central authority for the assignment and management of IP addresses and domain names (ICANN, 2008). ICANN then delegates those responsibilities to authorized third parties.

The current technology and approach for directory services does not handle the problems posed by the interactions between multiple private networks or difficulties associated with a central Domain Name System. Those issues become evident in the case of ad hoc networks or social peer to peer networks (e.g. Tam et al., US Patent App. 20060259957) where devices and services on any particular network may exist temporarily.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the invention is to provide a system and method for navigating and accessing resources on private and public networks.

In accordance with one aspect of the invention, there is provided a system for discovery of network resources associated with one or more private networks, said system comprising: one or more cooperatively associated servers, comprising a database including information relating to said network resources; wherein said one or more servers are configured to respond to a user with information relating to a specific network resource on reception of an input query therefrom, when said input query includes any one of one or more labels previously registered with said servers as associated with said specific network resource.

In accordance with one aspect of the invention, there is provided a method of discovering network resources associated with one or more private networks, said method comprising: providing one or more servers including information relating to said network resources; submitting an inquiry requesting information relating to a specific network resource; and receiving said information from said one or more servers wherein said inquiry contains one or more labels previously registered with said servers as associated with said specific network resource.

In accordance with an aspect of the invention, there is provided an input query is submitted through a device such as a network access apparatus, stand-alone executable program, a user interface device such as touch screen or a user interface element such as a microphone, a location field of a web browser or a hyper text link. A software program processes the input query and determines whether the input query is directed at a Private Network Name Server (PNNS). The PNNS interprets any request targeting private networks and returns the appropriate information satisfying the request. With the appropriate logic, this PNNS can also handle the situation when the input query concerns information or resources on other private networks or requests to and from a public network such as the Internet.

The system and method of the invention allows for navigating and accessing network resources and/or services across multiple private networks and allows such networks to interact with public networks such as the Internet. The described system and method allows members of private networks to organize and label devices, services, and content such as but not limited to files, folders or directories, web pages, blogs, etc. on their private network. They can also control this label behaviour across other private networks as well as its interaction with public networks such as the Internet. The private network may be an ad-hoc network, for example. The invention provides a directory service to facilitate discovery of resources within a private network, between a plurality of private networks or between private and public networks.

### BRIEF DESCRIPTION OF THE FIGURES

These and other features of the invention will become more apparent in the following detailed description in which reference is made to the appended drawings.

FIG. 1 shows exemplary private networks that may utilize the system and method of the present invention.

FIG. 2 shows an exemplary configuration of private networks, utilizing dedicated Private Network Name Servers (PNNS) and Network Managers.

FIG. 3 shows an exemplary configuration of private networks, utilizing a shared Private Network Name Server (PNNS) and Network Manager, which is further linked to a public network.

FIG. 4 shows a configuration, wherein the functionality of the Private Network Name Server (PNNS) is combined in the same network module as the Network Manager, in accordance with embodiments of the invention.

FIG. 5 shows a configuration, where a private network can be accessed by a user through a trusted third party service such as a web server, in accordance with embodiments of the invention.

FIG. 6 presents an exemplary flow chart for registering a label for a network resource by a member of a private network, in accordance with embodiments of the invention.

FIG. 7 presents a flow chart for searching and discovering network resources on private and/or public networks using labels, in accordance with embodiments of the invention.

FIG. 8 schematically illustrates the relationship of the private networks via common members, in accordance with one embodiment of the invention.

### DETAILED DESCRIPTION OF THE INVENTION

The invention represents a system and method of storing and organizing information about private and optionally public networks, and their network resources. This invention establishes procedures on how private networks can interact with each other and how private networks can interact with a public network such as the Internet.

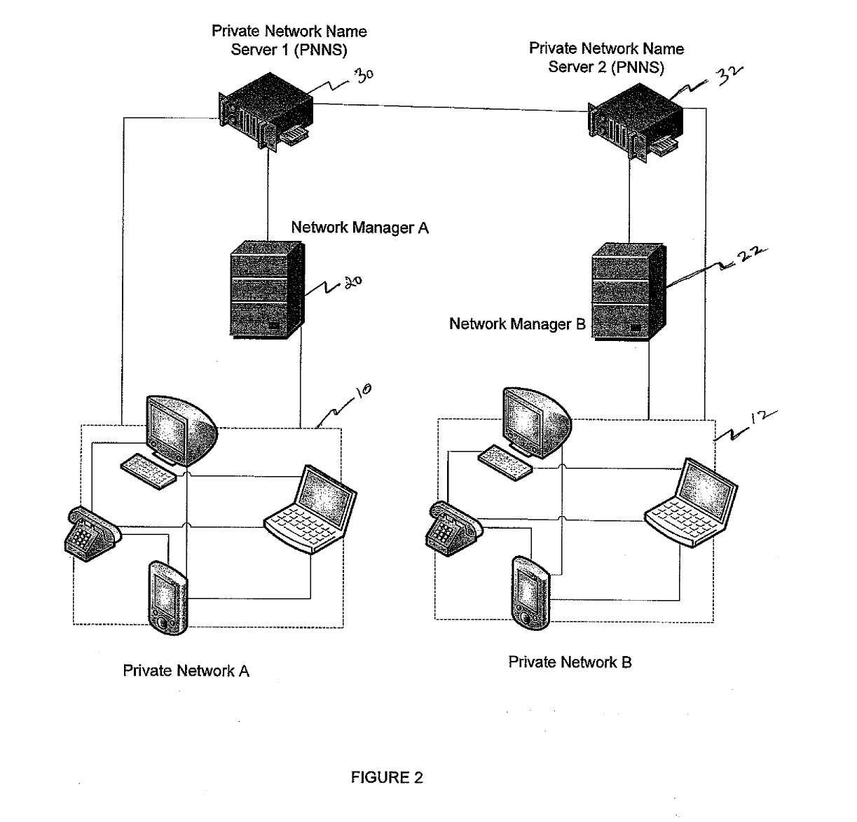

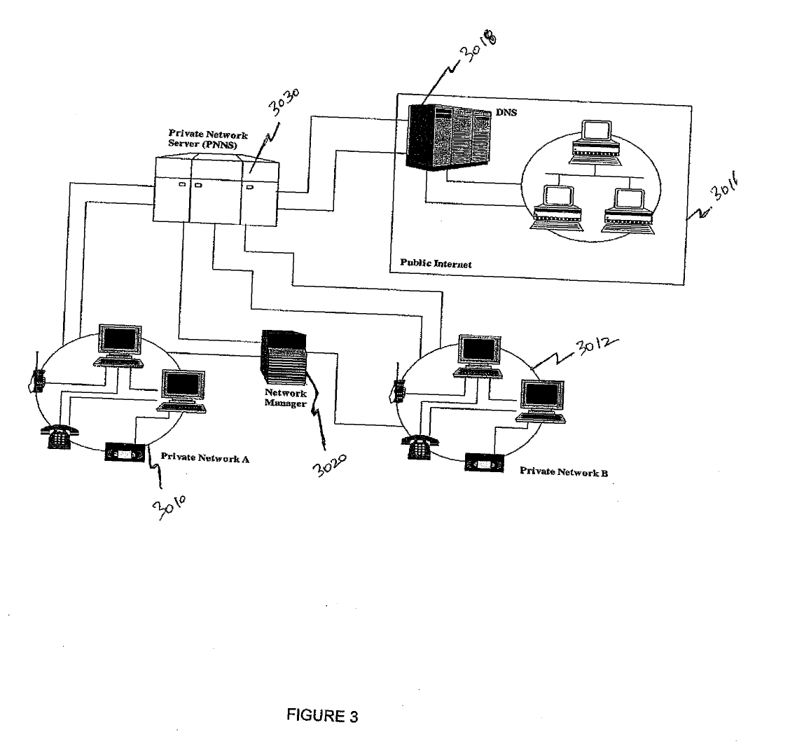

The present invention utilizes one or more Private Network Name Servers (PNNS) to provide directory service. A member of a private network may submit an input query, compliant with an agreed upon communication protocol, to one or more PNNS associated with his/her private network, which comprises a database with information regarding network resources, and returns the appropriate information satisfying the query to the member initiating the query. The PNNS also comprises appropriate logic to handle the situation when the input query concerns information or resources on other private networks or requests to and from a public network such as the Internet. In some embodiments and referring to FIG. 2, each private network 10, 12 may have a dedicated PNNS 30, 32, and the various PNNSs 30, 32 are configured for exchange of information regarding network resources. In some embodiments, multiple private networks 3010, 3020 may share a PNNS 3030, as shown in FIG. 3. A worker skilled in the art would appreciate that for the Internet (an example of a public network), the information relating to the network resources associated therewith may be accessed using the DNS servers.

A private network may be defined by a plurality of computers and electronic resources. In some embodiments, the formation of a private network may be initiated by a network user who utilizes a process (e.g. an invitation procedure) to create a list of contacts, and defines these contacts to be part of the private network. In some embodiments, devices associated with a private network must have a software client installed thereon, in order to be part of the private network, wherein the software client can determine whether information or requests for information should be communicated using the private network.

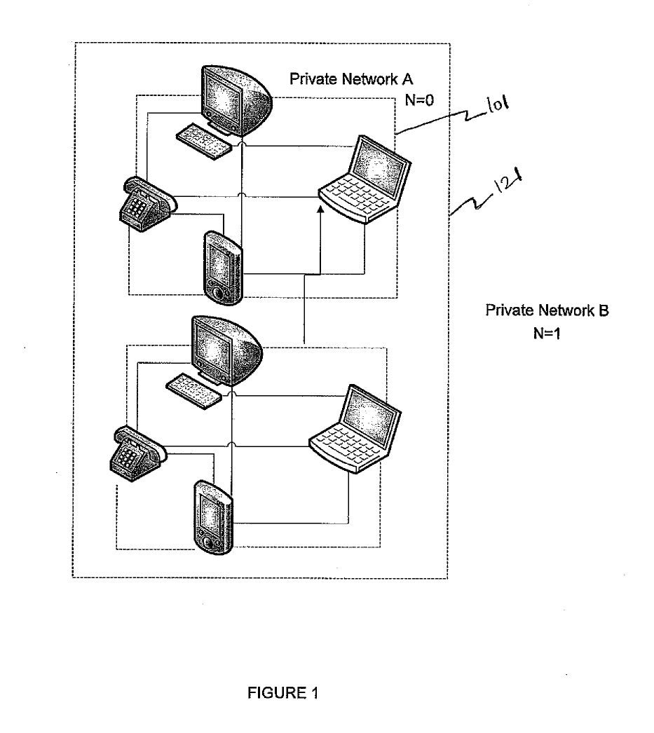

Two private networks may share common nodes. In some embodiments, a first private network 101 may be a subset of a second private network 121, as exemplarily shown in FIG. 1. For example, a private network A 101 may comprise a member and all users who have a relationship of trust with said member; while a private network B 121 may comprise of said member and all users with a degree of separation of less than two with said member, wherein the degree of separation is indicative of the number of relationships of trust linking a user and the member. The private network A 101 may thus have a degree of separation (N) of zero between its various members, while the private network B 121 will have a degree of separation of one.

In some embodiments, members of a private network can connect to the private network by accessing a service on a public network such as the Internet. An example of such a service would be a web based application that can connect to the private network through a trusted intermediary (e.g. web server). A worker skilled in the art will readily understand that a private network in comparison to a public network may have a much higher expectation of security and access control by members of the network.

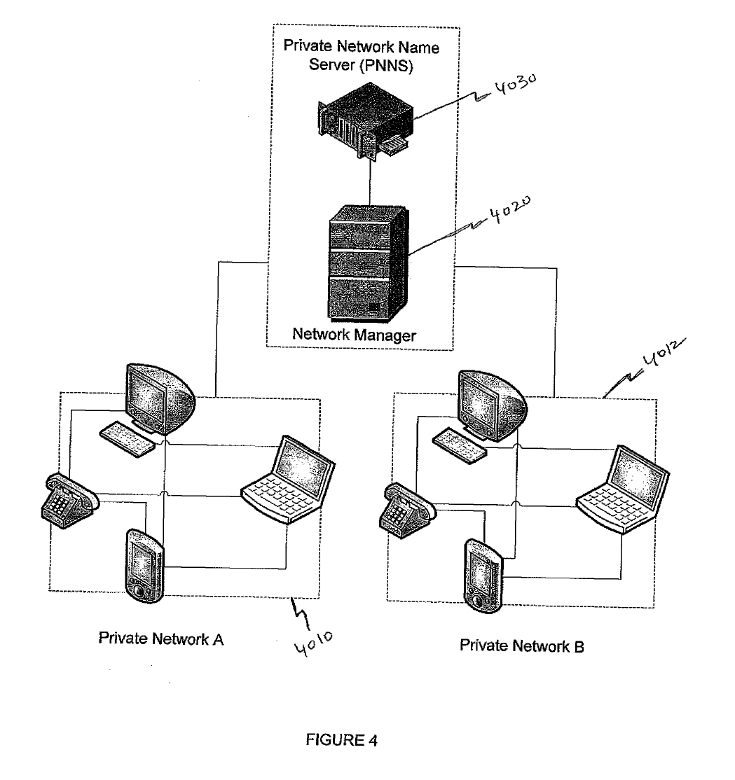

The PNNS comprises a database that matches labels to network resources and is configured to handle communication between networks. A network may additionally comprise a Network Manager (NM), which may be operatively associated with its PNNS to ensure that information relating to various network resources and/or members of the private network is updated regularly. In some embodiments, the functionalities of the PNNS 4030 and the NM 4020 may be combined in a single network node, as shown in FIG. 4. A private network may comprise a NM that is responsible for authenticating and verifying each member on a private network, and is also responsible to provide information to PNNS for updating the network resource identifier of each network resource. Updates relating to a member of the private network and/or any network resources owned thereby, may be provided by the NM to the PNNS periodically, or at login of the member to the network.

A user may register a label with a PNNS, wherein said label is associated with a network resource, and thus to its network resource identifier. A worker skilled in the art would appreciate that a network resource may include anything that is attached to a network, and is not limited to computers, files, folders, directories, web pages, blogs, services, electronic devices, memory space, processing power. A member may register a label to identify a network resource that exists within the member's own private network, on another private network or on the public Internet. A label can be any character string or memory aid that can represent the network resource. A network resource identifier may exemplarily be an unique IP address used to find the network resource.

A PNNS responds to queries about network resources based on the query, the permission settings of the network resources corresponding to the label, and the overall behavior of the system. In some embodiments, a member of a private network may use any electronic or computing device to transmit a query to its associated PNNS, wherein said electronic or computing device has a software client installed thereon to ensure that communication with the PNNS is compliant with the agreed upon protocol for protocol between members of the private network and the PNNS. The software client sends the query to the PNNS and accepts the reply from the PNNS. In embodiments where a member of a private network uses a trusted third party to communicate with the PNNS and/or NM of the private network, the trusted third party may ensure compliance with the agreed upon communication protocol.

The information obtained from the PNNS may be used the member initiating the query to determine further actions. For example, the member may access the specific network resource, or continue querying for alternate network resources.

The various properties of the query may be set by the member initiating the query. Examples of query properties include but are not limited to: the extent of the search (e.g. within the private network, across other private networks based on some parameters or allow the query to extend to the Public Internet), the properties of networks resource (web, device, user, etc.).

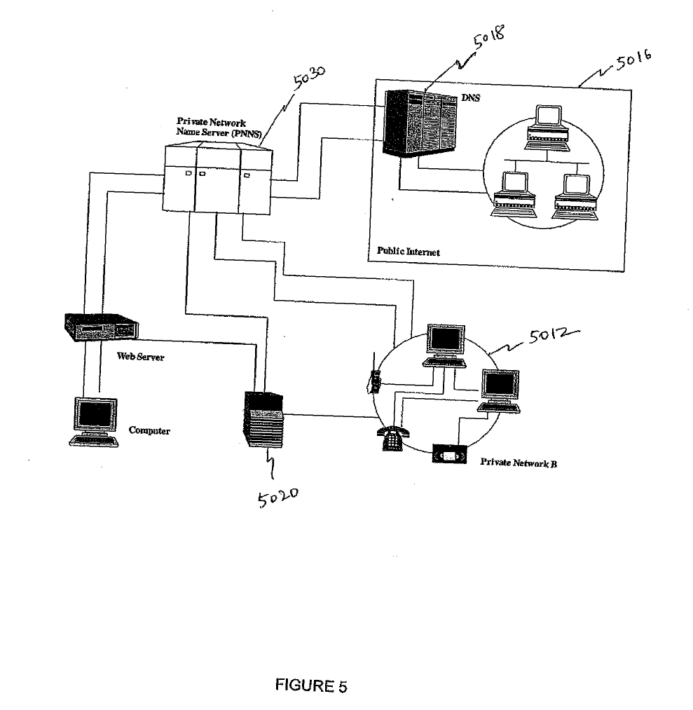

A member of a private network may also use a trusted third party to communicate with the private network's PNNS and/or NM. In one embodiment and referring to FIG. 5, the trusted third party is a web server that is available for public access but can communicate with the PNNS and/or NM. Once a member has been authenticated via login from the trusted third party as being a part of private network then the member can send a label query through the trusted third party to the PNNS and receive a response from the PNNS. For example, a member can login to a website, send a label request using http through the website, the server forwards this request to the PNNS, the PNNS receives the request, acts on the request and sends back the result back to the web server which then displays the result to the member.

A query can have different characteristics. For example, a query can be limited to all members within a private network; or can be extended to other private networks based on some criteria, such as exemplarily, the degree of separation; or may extend to include a public network such as the Internet.

The permission of a network resource is set by the owner of the specific network resource. For example, a member may define his/her memory devices as a network resource, but may limit its access to only by the other members of his/her private network. Permission to access a network resource may be chosen from a variety of options including but not limited to the following four options: (a) limiting access to members of one private network; (b) limiting access to particular devices on a private network; (c) extending access to other private networks based on particular criteria and/or rules; (d) extending access to a public network such as the Internet.

Various aspects of the directory service of the present invention may be modified, for example, by controlling the behaviour of the system comprising the private networks, the public network and the PNNS. Examples of these aspects include:
The communication protocol. For example, in one embodiment, any label query must begin with a string, such as “h22p://” following by a text string. The installed software on the network device can then detect any input request that matches this communication protocol and directs the communication to the PNNS. In one exemplary embodiment, the text strings is compliant with the Unicode character sets.
The response of the PNNS to a query may be of different types. For example, in the event of a successful match of the label to a single network resource, the PNNS return the IP address of the network resource associated with the label. In the event of successful match of the label to multiple network resources, the PNNS may provide a list of all network resources that matched the queried label. If there is no success in matching a label, the PNNS may provide a system message indicating the same, or provide a list of similar network resources and their locations, or redirect the query initiating user to one of such similar network resources. The PNNS may also redirect said query initiating member to a process for registering and assigning a label, in the event of an unsuccessful label match.
Private networks may be defined in different ways. For example, private networks can be related by degree of separation, for social networks. Private networks may be related by criteria such as the nature of devices or geography.
Various aspects relating to the registration, organization and management of the labels and their associated network resources may be adapted including:
   The rules regarding label ownership may be altered. For example, a label may be used only once for a private network. Additionally, labels may be reserved only for a set period of time; or available based on a ‘first come, first served’ basis. Labels may also be restricted to certain formats.
   The rules for the behaviour of the label across different private networks and the public network may be altered. For example, these rules may includes rules to handle the use of same labels across multiple private networks; rules to deal with searches from other private networks, and rules to deal with behaviour of labels from searches originating from public networks.

FIGS. 3 and 5 show two exemplary configurations comprising private network(s) and a public network (e.g. Internet), and utilizing the directory service of the present invention. The private network(s) comprise different members and devices, and may have been created by an invitation process that may be controlled by a shared NM. The private networks may share a PNNS. A private network may be defined for the purposes of this exemplary configuration as a network whose members have controlled access over each other's resources. In addition, each member's identity must be verified in order for the member to gain access to the network's resources. The process of identification and location of resources is carried out by the NM. In comparison, a public network such as the Internet does not have access controls or need such authentication processes. The Domain Name System (DNS) 3018, 5018 is responsible for locating a resource on the Internet 3016, 5016. Technically, the communication between members of a private network can be carried out over a public network with the proper security and control.

Members of a private network access the private network through the NM. After logging on to the system, a member can then register a label for a resource with the PNNS or query labels on their own private network, other private networks or to public networks such as the Internet.

Referring to FIG. 3, the members of the private networks 3010, 3012 may access the network using devices with appropriate software installed thereon that controls the communication and connection to the private network. Referring to FIG. 5, the private network 5012 may also be accessed by a member through a web server on a public network. In this scenario, this member can use a computer without installing the communication software and login to the web server which communicates with the NM. After the member's identity has been verified by the NM 5020, the member can database of the PNNS 5030.

In some embodiments, a member of a private network may choose to set the permission of his/her network resource (e.g. content) such that it is publicly available ie., available to anyone on any network. In this scenario, any one on a public network such as the Internet can contact the PNNS directly and obtain information about that publicly available content (or resource). An example of this process is as follows:
The web server is a search engine or directory service.
Search engine sends a request to PNNS using a standard Internet communication protocol (e.g. http)
PNNS translates the search engine's request into the communication protocol of the private network so that the search engine can access the content.
The search engine can then index this publicly available content and identify this content based on a label maintained by the PNNS.
Anyone on the public network can click on this label from the search engine and a http request is sent to the PNNS and translated as a request to the private network.

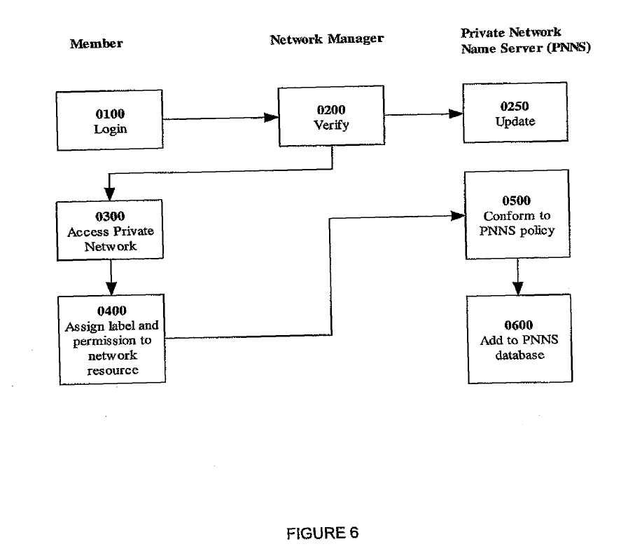

FIG. 6 is a flowchart for an exemplary label registration process initiated by a member of a private network. This registration process is composed of the following steps:
0100—Login—A member first logs in to the private network by contacting the NM.
0200—Verify—The NM verifies the supplied login information and allows network access only if the supplied information is correct.
0250—Update—On a successful login, the NM updates information that is required by the PNNS, such as for example, regarding availability of network resources controlled by the member, and their geographical locations, IP address etc. In some embodiments, the information relating to the network resources of a member may be updated not just at login of the member, but also periodically while the member is logged on the private network.
0300—Access Private Network—The member can now access the private network, allowing the member to access a list of the resources available to the member; and access these resources using labels defined in the PNNS.
0400—Assign label and permission to network resource—The Member can assign a label such as a text string to a network resource. Examples of network resources include: a file on a local computer; a folder on his local computer; a resource on member of his private network; a resource on another private network; a public internet site.

The member can also assign permission to the resources owned by the member. These permissions will govern the search and access behaviour for the network resource. Example of permission would include: the degree of separation for social networks, the type of devices that the network resource could support, etc. These settings are then sent to the PNNS.
0500—Conform to PNNS policy—PNNS verifies that the information supplied by the member conforms to policy of the system. Example of system policy includes proper format, ownership rights and usage agreements.
0600—Add to PNNS database—PNNS stores this relationship in the database.

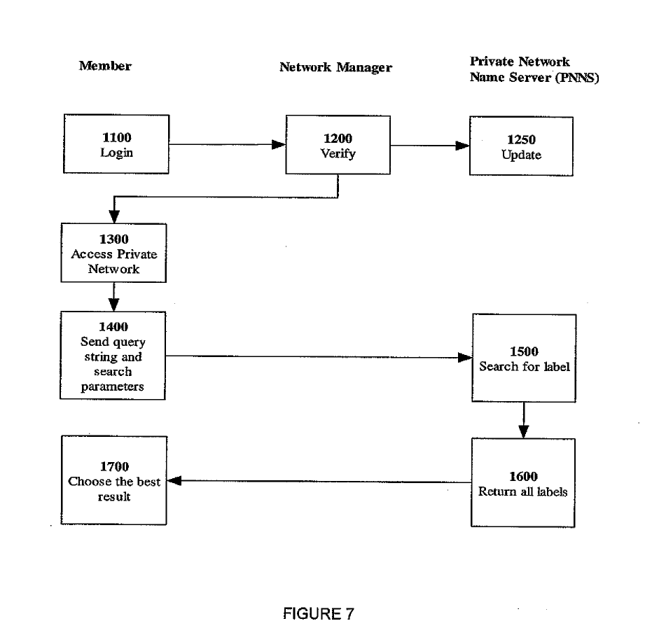

FIG. 7 is a exemplary flowchart for searching and discovering network resources on private and public networks using labels, by a member of one of the private networks. This searching process is composed of the following steps:
1100—Login—The member first logs in to the private network by contacting the NM.
1200—Verify—The NM verifies the supplied login information and will allow network access only if the supplied information is correct.
1250—Update—The NM updates information that is required by the PNNS based on information that is obtained from the member logging in.
1300—Access Private Network—The Member can now access their private network. Access means for example, that the member receives a contact list of the resources that are online and available to the member.
1400—Send query string and search parameter—It is assumed that each member's device has installed a software layer that can recognize communication and connection to the private network. This software will be required when the member first connects to the private network. The Member can search for network resource based on a query and a set of search parameters. A query can be any digital representation but it is typically represented by a string of characters. Search parameters are based on the label permissions and provide a means of controlling the search. Example of search parameters would include: the degree of separation for social networks, the type of devices that the network resource that the member is interested in, etc. This information is then sent to the private network name server.
1500—Search for label—the PNNS searches the database for all labels that meets the query and the search parameters.
1600—Return all labels—Since the search can be carried out for multiple private networks, there could also be multiple labels for different network resources. PNNS will return all labels the member.
1700—Choose the best result—A member can choose from all the network resources defined by the label. The criteria for choosing may include but are not limited to the geographical proximity and/or capability of the network resource.

To gain a better understanding of the invention described herein, the following examples are set forth. It will be understood that these examples are intended to describe illustrative embodiments of the invention and are not intended to limit the scope of the invention in any way.

### EXAMPLES

### A. Registering a Label with a Private Network Name Server (PNNS)

The following is an example of the steps required by a user A1 to apply a label to a network resource:
1. User A1 is a member of a private network comprised of three other members A2, A3 and A4.
2. User A1 logs on to NM which allows him access to the PNNS.
3. User A1 assigns text string (label) to represent devices on this private network. This assignment is stored as a table in the database portion of the PNNS. See exemplary table below.

| User | Label | Devices | Description |
|---|---|---|---|
| A1 | www.A1.com | Home | The computer that is sharing files/ |
| | | computer (IP | resources on the private network |
| | | address) | |
| A1 | www.A1.com/start.htm | A html | Home computer and the location |
| | | document | on the computer of a web named |
| | | | “start.htm” |
| A1 | A1_cellphone | Cell phone (IP | A cell phone belonging to W. |
| | | address) | |
| A1 | Safe Internet | Public | A webpage or a device access on |
| | | Internet | the public Internet. |

4. User A1 assigns various permission settings for the network resources associated with the various labels. These settings will define where the corresponding label can be applied. In one example, for social networks, the degree of separation (N1) can be assigned for the string. An representative example in this case will be:
   N1=0, the label is only valid for the private network.
   N1>1, the label is valid for other private networks based on a degree of separation.
   N1=Internet, the label is valid for both private networks as well as any query directed at the Internet.
The settings are stored in a table in the PNNS database, as exemplarily shown below.

| Label | N1 |
|---|---|
| www.A1.com | Internet |
| A1_cellphone | 2 |
| Safe Internet | 1 |

### B. Normal Operation on a Private Network

The following is an example of a typical operation carried out on one private network.

### Setup

Users: B1 and B2 on a private network.

Each user assigns a label name to a service. The PNNS for this network contains a database table with the following information:

| User | Label name | Devices |
|---|---|---|
| B1 | B1 Home Computer | B1 Home computer (IP |
| | | address) |
| B1 | www.B1.com/start.htm | A html page on B1's home |
| | | computer |
| B2 | B2 cellphone | Cell phone (IP address) |
| B2 | XXYY | B2 Home computer (IP |
| | | address) |

### Examples

1. B1 and B2 are authenticated members of the private network. The NM updated the PNNS records and IP addresses in its database.
2. B2 enters the string “B1 Home Computer” on a computer. The computer has software installed that can recognize the format of this query, relays the information to the PNNS, the PNNS returns with the last known IP address of B1's home computer.
3. B2 enters the string “www.B1.com/start.htm” on a computer. The computer has software that can recognize the format of this query, relays the information to the PNNS, the PNNS returns with the last known IP address of B1's home computer and the physical location on B1's computer where the html page “start.htm” is located.
4. B1 enters the string “B2 cellphone” on a cell phone. A software on the cell phone recognize it is a query to a private network and relays the information to the PNNS, the PNNS returns with the last known IP address of the B2's cell phone address.
5. B1 enters the string “XXYY” on an electronic device. Software on the device recognize it is a query for a private network, relays the information to the PNNS, the PNNS returns with the last known IP address of the B2's home computer.

### C. Operating in a System that can Connect to Both Public and Private Networks

This example describes the general scenario where a member's system can access both the public Internet and a private network.

### Setup

Users: B1 and B2 on a private network. B1 and B2 can both connect to a Private network and the public Internet. Both B1 and B2 use a browser as the user interface. Both B1 and B2 have software installed that can differentiate between connection for a private network and to public network.

The communication protocol for the private network is defined by the string “h22p://” and any string following this will be a label defined by a member of a private network.

Each user assigns a label name to a service. The PNNS for this network contains a database table with the following information:

| User | Label name | Devices |
|---|---|---|
| B1 | B1 Home Computer | B1 Home computer (IP address) |
| B1 | www.B1.com/start.htm | A html page on B1's home computer |
| B1 | B1 favorite | www.someaddress.com (an Internet |
| | | website on the Internet) |
| B2 | B2 cellphone | Cell phone (IP address) |
| B2 | XXYY | B2 Home computer (IP address) |
| Internet | www.someaddress.com | A Internet website |

### Examples

1. B1 enters a string “h22p://B2 cellphone” on his web browser. This request is sent to the installed software, which determines that the communication is for the PNNS server and sends the request to the PNNS server.
2. B2 enters the string “http://www.someadress.com” on a browser. The installed software recognizes that the query is for the public Internet and transmits the message accordingly.
3. B2 enters the string “h22p://www.B1.com/start.htm” on a browser. The computer has software that can recognize the format of this query, relays the information to the PNNS, the PNNS returns with the last known IP address of B1's home computer and the physical location on B1's computer where the html page “start.htm” is located.
4. B1 enters the string “h22p://B1 favorite” on a browser. The computer has software that can recognize the format of this query, relays the information to the PNNS, the PNNS returns with the Internet page of www.someaddress.com.

### D. Communication Between Private Networks

The following example illustrates the interactions between different private networks. In this example, each member of a private network can themselves be members of other private networks. Each user can assign labels to network resources and control the behavior of those labels. Each user can also control the behavior of their query though search parameters. For example, in a social network, the search parameter can be the degree of separation. Other examples of search parameters include: geography or devices.

### Setup

Consider the following private networks (C1, C2 . . . Cn) with members (V3, W3, . . . Cn4). The complete member list is given as follows:

| C1 | C2 | C3 | C4 | C5 | Cn |
|---|---|---|---|---|---|
| V3 | O1 | D1 | O1 | T1 | Cn1 |
| W3 | R1 | E1 | R2 | T2 | Cn2 |
| X3 | | X3 | R3 | R3 | Cn3 |
| Y3 | Y3 | Y3 | | T3 | Cn4 |

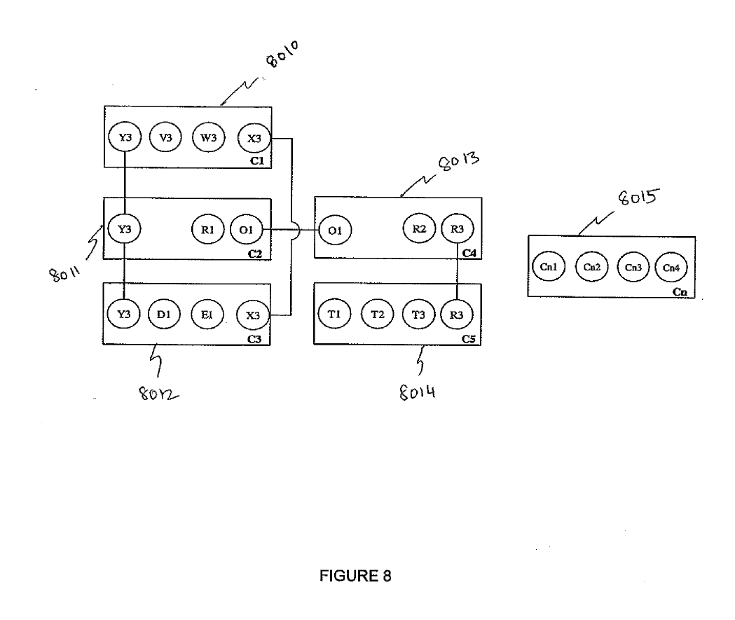

The relationship of the various private networks 8010, 8011, 8012, 8013, 8014, 8015 is visually presented in FIG. 8.

The PNNS system must be setup with some predefined system parameters to ensure interoperability. This example, the PNNS system will be configured so that:
Labels follows the Internet domain name convention so that
   Labels are text strings
   Host is separated by a “.”
   The right most text defines a top level domain
   Example of such a label will be—this.example.org
Communication to the PNNS is defined by a unique prefix string. In this example, the string is “h22p://”
Login/authentication system (e.g. NM) supplies the latest IP address, the type of device (telephone, Web) and the geographical location (North America, Europe) of the member.

On the PNNS, each member can assign a label to one or more of their network resources. Each member can also assign conditions that dictate the behaviour of those labels. The information can be stored as a table in the PNNS database. An example of this type of table is given as follows:

| | | Network | Label behavior | | |
|---|---|---|---|---|---|
| Member | Label | Resource | N | Device | Geography |
| Cn1 | Name1 | IPCn1 | Public | All | All |
| Cn2 | | | | | |
| Cn3 | | | | | |
| Cn4 | | | | | |
| D1 | friend.com | IPD1 | All | All | All |
| E1 | friend.com | IPE1 | 0 | All | All |
| O1 | | | | | |
| O1 | | | | | |
| R1 | 123456 | IPR1 | 0 | Phone | All |
| R2 | 123456 | IPR2 | All | Phone | All |
| R3 | 123456 | IPR3 | All | Web | |
| T1 | | | | | |
| T2 | | | | | |
| T3 | | | | | |
| V3 | | | | | |
| X3 | name.org | IPX3 | All | All | All |
| Y3 | | | | | |

Where:
Label can be any text string or agreed upon identifier.
Network resource identifier is a unique identifier for the network resource (typically an IP address)
Label behaviour is the user's chosen behaviour for the label as a result of a request. For example, in the case of social networks, the degree of separation (N) provides a means of controlling the access of the network resource. Other parameters can also be for example, devices (in this example, the choices will be: computer, mobile) or by geography (in this example, the choices will be: North America, or Asia).

The following are illustrations of how the system works when a specific user sends a query and the response from the PNNS. The comment section provides an explanation of the actions of the system.

### Search on a Private Network

V3: “h22p://www.name.org” “N=0”
PNNS: “IPX3”

PNNS searched for the label “www.name.org” amongst its members Y3, V3, W3 and X3. It finds the label name.org is associated with IPX3 and returns this value.

Search on a Private Networks that is One Degree of Separation Away from the User

This means you are searching your friend's labels as well as your friend's network's label.
V3: “h22p://www.friend.com” “N=1”
PNNS: “IPD1”

In this case, PNNS search for the label assign by Y3, W3, X3 that belong to the network C1. The search then extends to network C2 which contains members Y3, R1 and O1 as well as network C3, which contains members Y3, D1, E1, and X3. PNNS finds both members D1 and E1 has the required label. PNDS then look at the permissions for those labels. E1 has set up the permission so that only members of his network can access the resources (by setting N=0) but D1 allows anyway to access this label (N=All) so PNNS can return the result “IPD1”

Search on a Private Networks with the Setting for Public

This means you are searching for labels that are public.
V3: “h22p://Name1” “N=Public”
PNNS: “IPCn1”

PNNS searches for all public tags and returns the network resource associated with the label “Name1”. This example illustrates that the public setting allows a search on networks that are not associated through the degree of separation.

Search on a Private Networks with the Setting N=2 and Device=Telephone
V3: “h22p://123456” “N=Telephone”
PNNS: “IPR2”

PNNS searches for conditions that meet the specifications and returns the network resource “IPR2”

### E. Applying a Label to a Public Internet Resource for Members of a Private Network

In this example, the network resource can be an Internet destination and member of a private network can re-label this resource on his private network so other members of this service can search and access this internet resource based on this label.

### F. Applying a Label to Another Private Network Resource

In this example, a user on a private network has the ability to access a network resource on another private network. This user can then assign a label to this network resource even though he might not be a member of this private network.

### G. Communication from the Public Internet to a Private Network

A member must first login to a trusted website that has access to the Private Network Name Server. The member then can access used the PNNS labels on the private networks through this website.

### H. Handling Conflicts Between Different Labels on Different Networks

A query from a member of a private network can receive results from different private networks depending on the search and permission parameters. The PNNS can institute rules to reduce the possibility of duplicate labels. Example of rules could include: reserve words or time based priorities. A member can also choose from a list of duplicate labels and prioritize the result based on their own personal preference.

### I. Allow the Contents of a Private Network Searchable and Indexed by a Public Search Engine

A user on a private network can make contents on a private network available to a public network. In addition, they can make this content searchable and indexed by publicly available search engines. As a result, anyone on a public network can find and access specific information on a private network through a search engine.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

The embodiments of the invention in which an exclusive property or privilege is claimed are defined as follows:

1. A system for discovery of network resources associated with one or more private networks, said system comprising:
One or more cooperatively associated servers, comprising a database including information relating to said network resources; wherein said one or more servers are configured to respond to a user with information relating to a specific network resource on reception of an input query from said user, when said input query includes one or more labels previously registered with said servers as associated with said specific network resource.

2. The system of claim 1, wherein said one or more servers update said information relating to said network resources, based on information received from network managers of said private networks.

3. The system of claim 1, wherein said information relating to said specific network resource includes a current IP address of said specific network resource.

4. The system of claim 1, wherein said information relating to said specific network resource is provided to said user only when a permission setting of said specific network resource allows for its access by said user.

5. The system of claim 1, wherein each of said one or more servers is dedicated to one of said private networks and contains information relating to network resources associated therewith.

6. The system of claim 1, wherein said one or more servers allow for registration of a label as associated with a specific network resource, when requested by any one of the members of said private networks.

7. The system of claim 1, wherein said user is a member of said private networks.

8. The system of claim 1, wherein said network resources comprises network resources available on public networks.

9. A method of discovering network resources associated with one or more private networks, said method comprising the following steps:
providing one or more servers including information relating to said network resources;
submitting an inquiry requesting information relating to a specific network resource;
receiving said information from said one or more servers wherein said inquiry contains one or more labels previously registered with said servers as associated with said specific network resource.
